(19) United States
(12) Patent Application Publication
(10) Pub. No.: US 2013/0174395 A1
(43) Pub. Date: Jul. 11, 2013

(54) PIPE PRESS-CONNECTING APPARATUS

(71) Applicant: Kwang Chan Kim, Seoul (KR)

(72) Inventor: Kwang Chan Kim, Seoul (KR)

(73) Assignees: SEOWON TECHNOLOGY CO., LTD., Yongin-si, Gyeonggi-do (KR); Kwang Chan KIM, Seoul (KR)

(21) Appl. No.: 13/812,481

(22) PCT Filed: Jul. 21, 2011
(86) PCT No.: PCT/KR11/05366

§ 371 Date: Mar. 27, 2013

(30) Foreign Application Priority Data
Jul. 29, 2010 (KR) 10-2010-0073565

(51) Int. Cl. B23P 19/04

(52) U.S. Cl. CPC B23P 19/04
USPC 29/282

(57) ABSTRACT

Provided is a pipe fitting and clamping apparatus including a fixed block having a first sliding surface with a groove shape formed therein, a pair of pivot blocks pivoted about hinge pins installed at both of left and right ends of the fixed block and having second sliding surfaces rounded at inner sides thereof, a pair of first insert guides installed inside the fixed block and having rear surfaces which come in close contact with the first sliding surface and slide, a pair of second insert guides installed inside the pivot blocks and rounded such that rear surfaces come in contact with the second sliding surface and slide, and a plurality of inserts having front surfaces in contact with outer circumferential surfaces of pipes and rear surface which come in close contact with the front surfaces of the first insert guide and the second insert guide and slide.

According to the pipe fitting and clamping apparatus, since the pivot blocks are connected to both of left and right ends of the fixed block to compress the pipes using the principle of the lever, the compressing force can be increased with a small force during the compressing operation, and since the inserts are slid along the first and second insert guides to surround the entire circumference of the pipes and uniformly apply a pressure thereto upon rotation of the pivot blocks, the pipes can be compressed in a perfect circle shape.

### TECHNICAL FIELD

The present invention relates to a pipe fitting and clamping apparatus, and more particularly, to a pipe fitting and clamping apparatus configured to uniformly press the entire circumference of pipes to fit and connect the pipes.

### BACKGROUND ART

In general, when metal pipes such as stainless steel pipes used for a water supply service and indoor/outdoor pipes of buildings are connected to each other in a longitudinal direction thereof, a metal ring or a rubber ring is interposed in a connecting section, and the connecting section is pressed by a compression tool to maintain airtightness of it.

As described above, a pipe fitting and clamping apparatus for maintaining airtightness of the connecting section is disclosed in Korean Publicized Patent No. 2009-0094908 and Patent Registration No. 10-0762293.

FIG. 1 shows an embodiment of the invention disclosed in Korean Publicized Patent No. 2009-0094908, and FIG. 2 shows an embodiment of the invention disclosed in Korean Patent Registration No. 10-0762293.

As shown in FIG. 1, Korean Publicized Patent No. 2009-0094908 discloses technical specifications related to a compressing tool including a body 10, a pair of body links 20 fixed to the body 10 by a fixing pin 30, a push rod (not shown) disposed and propelled between the body links 20, a plurality of insert guides 40 fixed to the body links 20 and disposed therein, a spring (not shown) attached to and sliding along the insert guide 40, and an insert 50 configured to install a spring pin 55 and fix the spring pin 55 to the insert guide 40.

However, the compressing tool disclosed in Korean Publicized Patent No. 2009-0094908 moves the push rod disposed between the body links 20 forward using a hydraulic cylinder to compress the pipes.

Since a forward force of the push rod is equal to a compressing force to pipes, a high pressure hydraulic cylinder is needed.

In addition, in the pipe compressing tool disclosed in Korean Publicized Patent No. 2009-0094908, the body links 20 are moved forward by the push rod, the insert 50 near the push rod first presses the pipes, and then imbalance in force occurs due to the insert 50 pressing the pipes in a direction perpendicular to an advancing direction of the body links 20. Accordingly, the pipe connecting section cannot form a perfect circle shape.

In addition, since the pipes are compressed using the high pressure hydraulic cylinder, the compressing tool itself may be damaged. In order to prevent the damage, when the thickness and weight of the compressing tool are increased, a working process may become uneasy due to the increased weight.

As shown in FIG. 2, Korean Patent Registration No. 10-0762293 discloses technical specifications related to a compressing tool including a plurality of arc blocks 60 configured to compress pipes inserted into an inner hole, first and second reference blocks 70 in contact with outer circumferential surfaces of the arc blocks 60 and integrally formed with guide holes 71 configured to guide sliding and prevent separation of the arc blocks 60, a plurality of support blocks 80 pivotally connected to each other between the first and second reference blocks 70 and in contact with the outer circumferential surfaces of the plurality of arc blocks 60 to support sliding of the arc blocks 60, and chain links 90 configured to pivotally connect the neighboring support blocks 80 from both of upper and lower sides.

However, in the compressing tool disclosed in Korean Patent Registration No. 10-0762293, the pipe compressing cannot be smoothly performed due to a chain slack phenomenon during a process of compressing the pipes through application of the high pressure, and the compressing section cannot have a perfect circle. In addition, the chain

### DISCLOSURE

### Technical Problem

In order to solve the foregoing and/or other problems, it is an aspect of the present invention to provide a pipe fitting and clamping apparatus in which pivot blocks are connected both of left and right ends of a fixed block and the pivot blocks are rotated to press pipes with a small force using the principle of the lever.

In addition, it is another aspect of the present invention to provide a pipe fitting and clamping apparatus in which first and second insert guides are installed inside a fixed block and pivot blocks, so that the first and second insert guides slide inside the fixed block and the pivot blocks upon rotation of the pivot block to press the entire circumference of pipes with a uniform pressure.

### Technical Solution

The foregoing and/or other aspects of the present invention may be achieved by providing a pipe fitting and clamping apparatus including: a fixed block having a first sliding surface with a groove shape formed therein; a pair of pivot blocks pivoted about hinge pins installed at both of left and right ends of the fixed block and having second sliding surfaces rounded at inner sides thereof; a pair of first insert guides installed inside the fixed block and having rear surfaces which come in close contact with the first sliding surface and slide; a pair of second insert guides installed inside the pivot blocks and rounded such that rear surfaces come in contact with the second sliding surface and slide; and a plurality of inserts having front surfaces in contact with outer circumferential surfaces of pipes and rear surfaces which come in close contact with the front surfaces of the first insert guide and the second insert guide and slide.

Preferably, the second insert guide may be rounded such that a thickness between the front surface and the rear surface is increased in a direction away from a center of the hinge pin.

More preferably, the rear surface of the second insert guide may have a first curved surface having a predetermined circumferential length at an end thereof adjacent to the hinge pin and a second curved surface continuously formed from the first curved surface, the first curved surface and the second curved surface may have the same radius of curvature, and a central point of curvature of the first curved surface from a central point of curvature of the front surface of the second insert guide may be farther than from a central point of curvature of the second curved surface.

Preferably, a first resilient member may be installed at surfaces of the plurality of inserts in contact with each other.

Preferably, a second resilient member may be installed between a bottom surface of the first sliding surface and the first insert guide.

Preferably, a third resilient member having a band shape configured to surround the outside of the fixed block and pivot blocks may be further installed.

### Advantageous Effects

According to a pipe fitting and clamping apparatus proposed by the present invention, since the pivot blocks are connected to both of the left and right ends of the fixed block to compress the pipes using the principle of the lever, the compressing force can be increased by only a small force during the compressing work to increase work convenience.

In addition, since the plurality of inserts slide along the first and second insert guides to surround the entire circumference of the pipes and apply a uniform pressure during rotation of the pivot blocks, the pipes can be compressed in a perfect circle shape.

Further, since the entire circumference of the pipes can be uniformly pressed to be fitted and can prevent oval deformation of the pipes, a defect such as leakage from the connected pipes can be prevented, and durability can be increased, extending an exchange period of the connected pipes.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 shows an embodiment of the invention disclosed in Korean Patent Application Laid-Open No. 2009-0094908;

FIG. 2 shows an embodiment of the invention disclosed in Korean Patent Registration No. 10-0762293;

FIG. 3 is an exploded perspective view showing a pipe fitting and clamping apparatus according to the present invention;

FIG. 4 is an exploded perspective view showing an insert and a second insert guide according to the present invention;

FIG. 5 is a cross-sectional view showing a curvature state of a rear surface of a second insert guide according to the present invention;

FIG. 6 shows an assembled state of the pipe fitting and clamping apparatus according to the present invention before pressing; and

FIG. 7 is a perspective view showing the pipe fitting and clamping apparatus upon pressing according to the present invention.

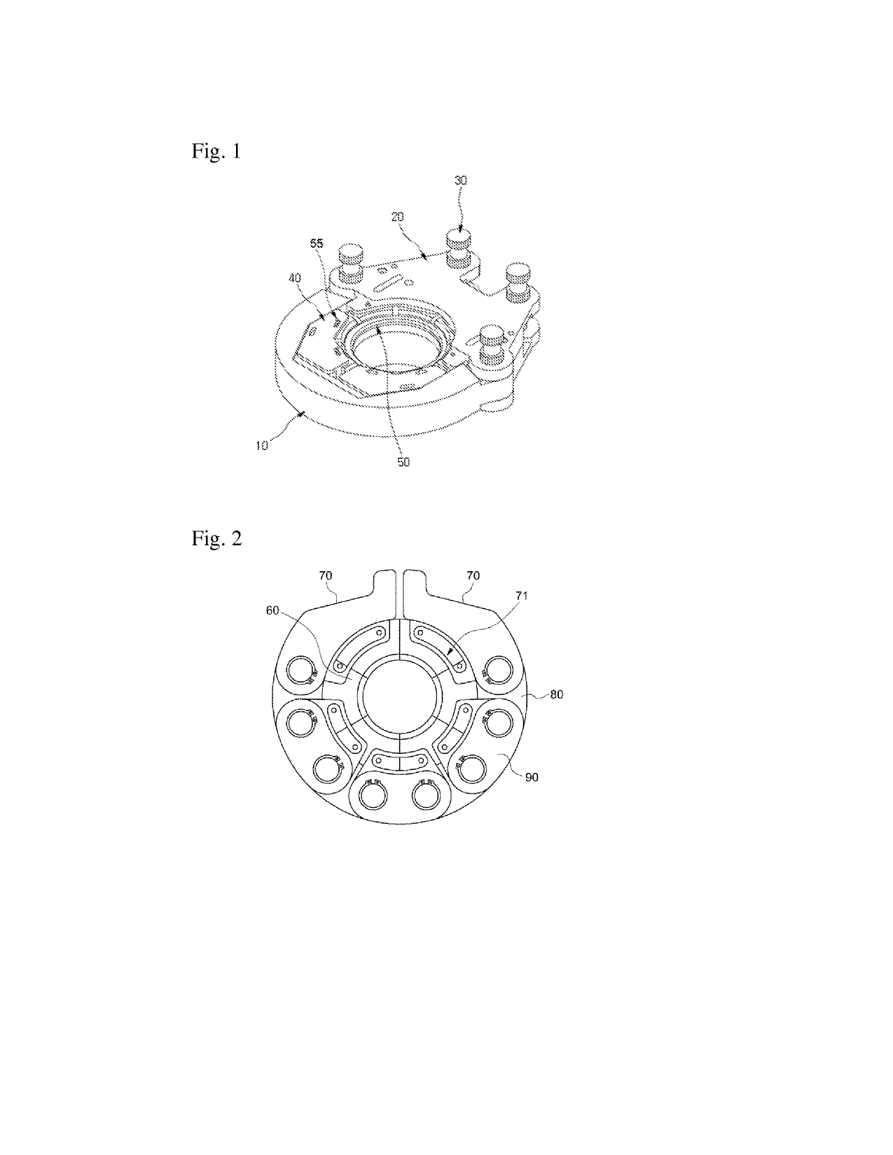

### MODE FOR INVENTION

Reference will now be made in detail to a pipe fitting and clamping apparatus of the embodiments of the present invention, examples of which are illustrated in the accompanying drawings.

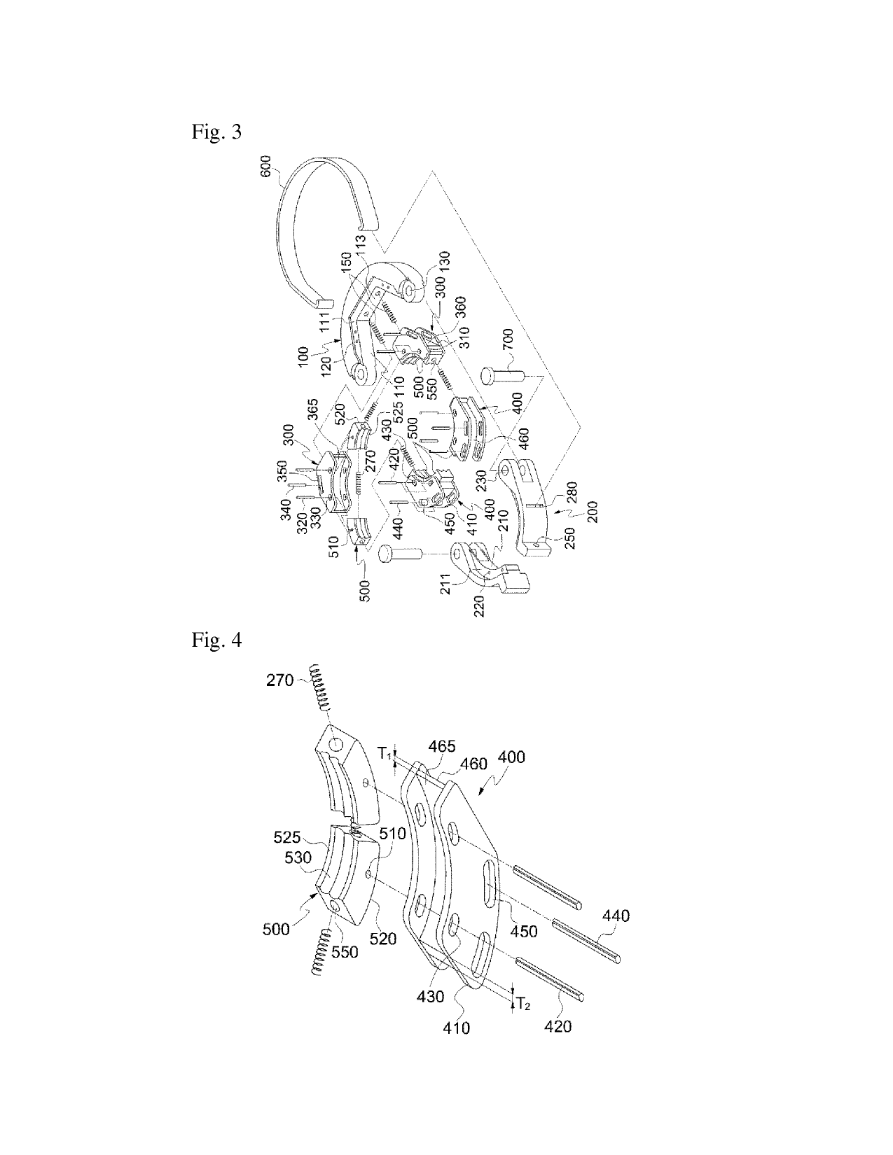

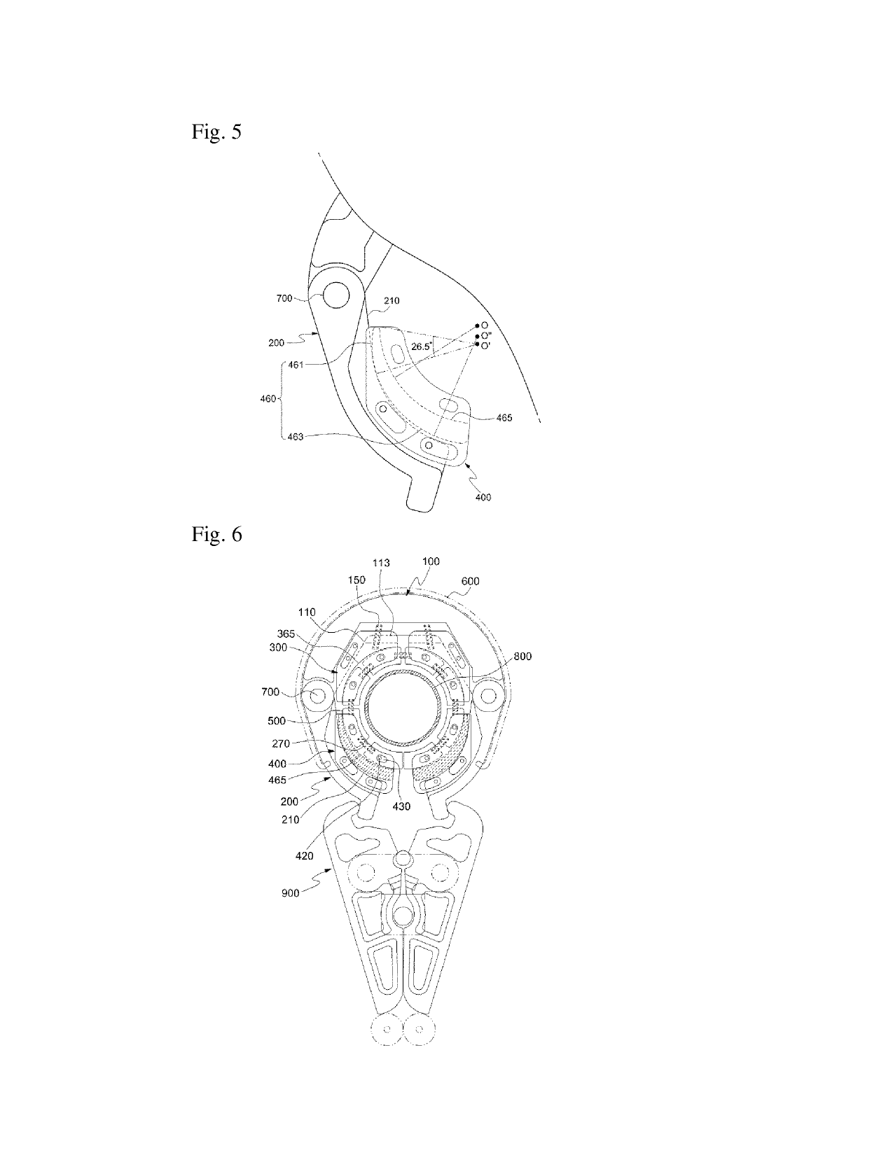

FIG. 3 is an exploded perspective view showing a pipe fitting and clamping apparatus according to the present invention, FIG. 4 is an exploded perspective view showing an insert and a second insert guide according to the present invention, and FIG. 5 is a cross-sectional view showing a curvature state of a rear surface of a second insert guide according to the present invention.

Referring to FIG. 3, the pipe fitting and clamping apparatus according to the present invention includes a fixed block 100, pivot blocks 200 connected to both of left and right ends of the fixed block 100 to be pivoted, a pair of first insert guides 300 slidably inscribed within the fixed block 100, a pair of second insert guides 400 slidably inscribed within the pivot blocks 200, a plurality of inserts 500 in close sliding contact with the first insert guide 300 and the second insert guide 400, first resilient members 270 installed at both ends in a longitudinal direction of the plurality of inserts 500, a second resilient member 150 installed between the fixed block 100 and the first insert guide 300, and a third resilient member 600 installed to surround the outside of the fixed block 100 and the pivot blocks 200.

The fixed block 100 includes a first sliding surface 110 having a groove shape formed therein. The first sliding surface 110 may have a polygonal shape such as a trapezoidal shape as shown in FIG. 3. A rear surface 360 of the first insert guide 300 (to be described later) slides along the first sliding surface 110.

In addition, the fixed block 100 includes first seating sections 111 stepped at upper and lower surfaces.

An inner side of a first side surface plate section 310 of the first insert guide 300 (to be described later) is closely installed at the first seating section 111, and the first insert guide 300 is coupled to the fixed block 100 by a second spring pin 340 and a pin hole 120 formed in the first seating section 111 (to be described later).

The pivot blocks 200 are coupled to the fixed block 100 through a hinge pin 700 passing through hinge holes 130 and 230 formed in both of left and right ends of the fixed block 100 and one ends of the pivot blocks 200.

In addition, fitting-fixing grooves 250 configured to receive forces applied from both of left and right sides are formed at the other ends of the pivot blocks 200. A pipe press instrument is connected to the fitting-fixing grooves 250 to rotate the pivot blocks 200.

The pivot blocks 200 are rotated about the hinge pin 700. The pivot blocks 200 function to press and fit pipes disposed inside the fixed block 100 and the pivot blocks 200 using the principle of the lever. The pivot blocks 200 can be pressed from both of left and right sides with a small force to be rotated inward to press and fit the pipes with a large force.

The pivot blocks 200 include second sliding surfaces 210 rounded such that a rear surface 460 of the second insert guide 400 is in close contact therewith and slides.

In addition, the pivot blocks 200 include second seating sections 211 stepped at the upper and lower surfaces.

An inner side of a second side surface plate section 410 of the second insert guide 400 (to be described later) is closely installed at the second seating section 211, and the second insert guide 400 is coupled to the pivot blocks 200 by a fourth spring pin 440 and a pin hole 220 formed in the second seating section 211 (to be described later).

The first insert guide 300 is installed such that the rear surface 360 comes in contact with the first sliding surface 110 of the fixed block 100. The rear surface 360 of the first insert guide 300 comes in contact with the first sliding surface 110 and slides. Here, two first insert guides 300 constitute one set. The one set of first insert guides 300 is symmetrically installed at the first sliding surface 110 of the fixed block 100 and forms quadrants.

The first insert guide 300 is spaced a predetermined gap from a bottom surface 113 of the first sliding surface 110 by the second resilient member 150 installed at the bottom surface 113 of the first sliding surface 110, and when the pivot blocks 200 are rotated to compress the pipes, the second resilient member 150 is compressed to come in contact with the bottom surface of the first sliding surface 110.

A front surface 365 of the first insert guide 300 is rounded such that a rear surface 520 of the insert 500 comes in contact therewith and slides.

A first spring pin guide hole 330 is formed lengthways in the first side surface plate section 310 of the first insert guide 300. A first spring pin 320 passes through pin holes 510 formed in the first spring pin guide hole 330 and the insert 500 to couple the first insert guide 300 and the insert 500.

When the insert 500 slides along the first insert guide 300 as the pivot blocks 200 are rotated, the first spring pin 320 is moved by a length of the first spring pin guide hole 330.

Accordingly, when a moving distance of the insert 500 on the first insert guide 300 is limited by a length of the first spring pin guide hole 330 upon rotation of the pivot blocks 200 and a force of raising the insert 500 is continuously applied, the first insert guide 300 coupled to the insert 500 is moved along the first sliding surface 110 of the fixed block 100.

In addition, a second spring pin guide hole 350 is formed lengthways in the first side surface plate section 310 of the first insert guide 300 to couple the first insert guide 300 to the fixed block 100. The second spring pin 340 passes through the pin holes 120 formed in the second spring pin guide hole 350 and the fixed block 100 to be coupled to the first insert guide 300.

When the first insert guide 300 slides along the first sliding surface 110 as the pivot blocks 200 are rotated, the second spring pin 340 is moved by a length of the second spring pin guide hole 350.

The second insert guide 400 is installed such that the rear surface 460 comes in contact with the second sliding surface 210 of the pivot blocks 200. The rear surface 460 of the second insert guide 400 comes in contact with the second sliding surface 210 and slides. Here, two second insert guides 400 constitute one set. The set of second insert guides 400 is symmetrically installed at the second sliding surface 210 of the pivot blocks 200 and forms quadrants.

Referring to FIGS. 3 and 4, a front surface 465 of the second insert guide 400 is rounded such that the rear surface 520 of the insert 500 comes in close contact therewith and slides.

A third spring pin guide hole 430 is formed lengthways in the second side surface plate section 410 of the second insert guide 400. A third spring pin 420 passes through the pin holes 510 formed in the third spring pin guide hole 430 and the insert 500 to couple the second insert guide 400 and the insert 500. When the insert 500 slides along the second insert guide 400 as the pivot blocks 200 are rotated, the third spring pin 420 is moved by a length of the third spring pin guide hole 430.

Accordingly, when a moving distance of the insert 500 on the second insert guide 400 is limited by the length of the third spring pin guide hole 430 upon rotation of the pivot blocks 200 and a force of raising the insert 500 is continuously applied, the second insert guide 400 coupled to the insert 500 is moved along the second sliding surface 210 of the pivot blocks 200.

In addition, a fourth spring pin guide hole 450 is formed lengthways in the second side surface plate section 410 of the second insert guide 400 to couple the second insert guide 400 to the pivot blocks 200. The fourth spring pin 440 passes through the pin holes 220 formed in the fourth spring pin guide hole 450 and the pivot blocks 200 to be coupled to the second insert guide 400.

When the second insert guide 400 slides along the second sliding surface 210 as the pivot blocks 200 are rotated, the fourth spring pin 440 is moved by a length of the fourth spring pin guide hole 450.

Meanwhile, when the pivot blocks 200 are rotated inward from both of left and right sides, in order to precisely compress the pipes in a perfect circle shape, as shown in FIG. 4, a thickness of the second insert guide 400 between the front surface 465 and the rear surface 460 is reduced toward the hinge pin 700. That is, as shown in FIG. 4, the thickness becomes T₂>T₁.

In addition, as shown in FIG. 5, the rear surface 460 of the second insert guide 400 may be constituted by a first curved surface 461 having a predetermined circumferential length from an end thereof adjacent to the hinge pin 700, and a second curved surface 463 continuously formed from the first curved surface 461.

The first curved surface 461 and the second curved surface 463 have the same curvature, central points of curvature O′ and O″ of the first curved surface 461 and the second curved surface 463 are disposed under a central point of curvature O of the front surface 465 of the second insert guide 400, and the central point of curvature O′ of the first curved surface 461 is disposed lower than the central point of curvature O″ of the second curved surface 463 with respect to the central point of curvature O of the front surface 465 of the second insert guide 400. That is, the central point of curvature O′ of the first curved surface 461 is disposed farther than the central point of curvature O″ of the second curved surface 463 from the central point of curvature O of the front surface 465 of the second insert guide 400.

According to the above-mentioned configuration, the first curved surface 461 has a shape bent inward toward a pipe center more than the second curved surface 463, and is spaced apart from the second sliding surface 210 as it goes toward an end of the hinge pin 700.

This is provided to allow the first curved surface 461 to prevent occurrence of interference with the second sliding surface 210 upon sliding rotation of the second insert guide 400. As a result of manufacturing and experimenting the device of the present invention for pipes having diameters of 50 mm and 30 mm, in both cases, the interference was prevented when a subtended angle of the first curved surface 461 was more than 26.5°.

The second curved surface 463 is configured such that the rear surface 460 of the second insert guide 400 comes in contact with the second sliding surface 210 when the pivot blocks 200 are pressed and pivoted.

Meanwhile, the front surface 465 of the second insert guide 400 forms a curved surface with a perfect circle shape such that outer circumferential surfaces of the pipes are seated and pressed.

Meanwhile, the inserts 500 are formed to round all of front surfaces 525 and the rear surfaces 520, and eight inserts constitute one set. The front surface 525 of the insert 500 is an area in connect with the pipes and maintains a perfect circle shape. In addition, the inserts 500 form pairs and slide along the first insert guide 300 and the front surface 465 of the second insert guide 400.

Four rear surfaces 520 of the inserts 500 come in close contact with the front surface 365 of the first insert guide 300 and slide, and the other four rear surfaces 520 come in contact with the front surface 465 of the second insert guide 400 and slide.

In addition, the front surfaces 525 of the inserts 500 constitute a plurality of compressing-groove sections 530 to compress a metal ring or a rubber ring interposed in a connecting section of the pipes.

The first resilient member 270 is inserted and installed in a groove section 550 formed by surfaces of the plurality of inserts 500 in contact with each other. Here, the first resilient member 270 may be formed of a coil spring. The eight inserts 500 are connected to each other by the plurality of first resilient members 270.

The first resilient member 270 functions to secure positions of the inserts 500 before the compressing.

The second resilient members 150 are installed between surfaces of the first insert guides 300 in contact with the bottom surface 113 of the first sliding surface 110 upon rotation of the bottom surface 113 of the first sliding surface 110 and the pivot blocks 200. The second resilient member 150 resiliently supports an upper portion of the first insert guide 300 such that the first insert guide 300 smoothly slides along the first sliding surface 110 by a force of raising the insert 500 installed at the front surface 465 of the first insert guide 300 from the insert 500 installed at the front surface 465 of the second insert guide 400 upon rotation of the pivot blocks 200.

The third resilient member 600 may have a flat spring shape configured to surround the outside of the fixed block 100 and the pivot blocks 200. A fixing-groove section 280 is formed at an outer surface of each of the pivot blocks 200, and both ends of the third resilient member 600 can be inserted and installed in the fixing-groove section 280.

The fixed block 100 and the pivot blocks 200 can be stored and installed while maintaining a certain shape without distribution by the third resilient member 600, and an unnecessary time consumed for assembly during a pipe compression process can be reduced. In addition, a safety accident in which an operator's hand is sandwiched between the fixed block 100 and the pivot blocks 200 during an operation can be prevented.

A state before the pipes are pressed using the pipe fitting and clamping apparatus according to the present invention will be described below.

FIG. 6 is view showing an assembled state of the pipe fitting and clamping apparatus according to the present invention before the pressing.

As shown in FIG. 6, pipes 800 are disposed inside the inserts 500. Then, a pipe press instrument 900 is connected to the fitting-fixing groove 250 of the pivot blocks 200.

Here, the plurality of inserts 500 in close contact with the front surfaces 365 and 465 of the first and second insert guides 300 and 400 have a larger diameter than that of the pipe 800 by a resilient force of the first resilient member 270 and are spaced a predetermined gap from each other.

In addition, the first insert guide 300 is spaced a predetermined gap from the bottom surface 113 of the first sliding surface 110 of the fixed block 100 by the resilient force of the second resilient member 150, and the second insert guide 400 is disposed at the second sliding surface 210 of the pivot blocks 200.

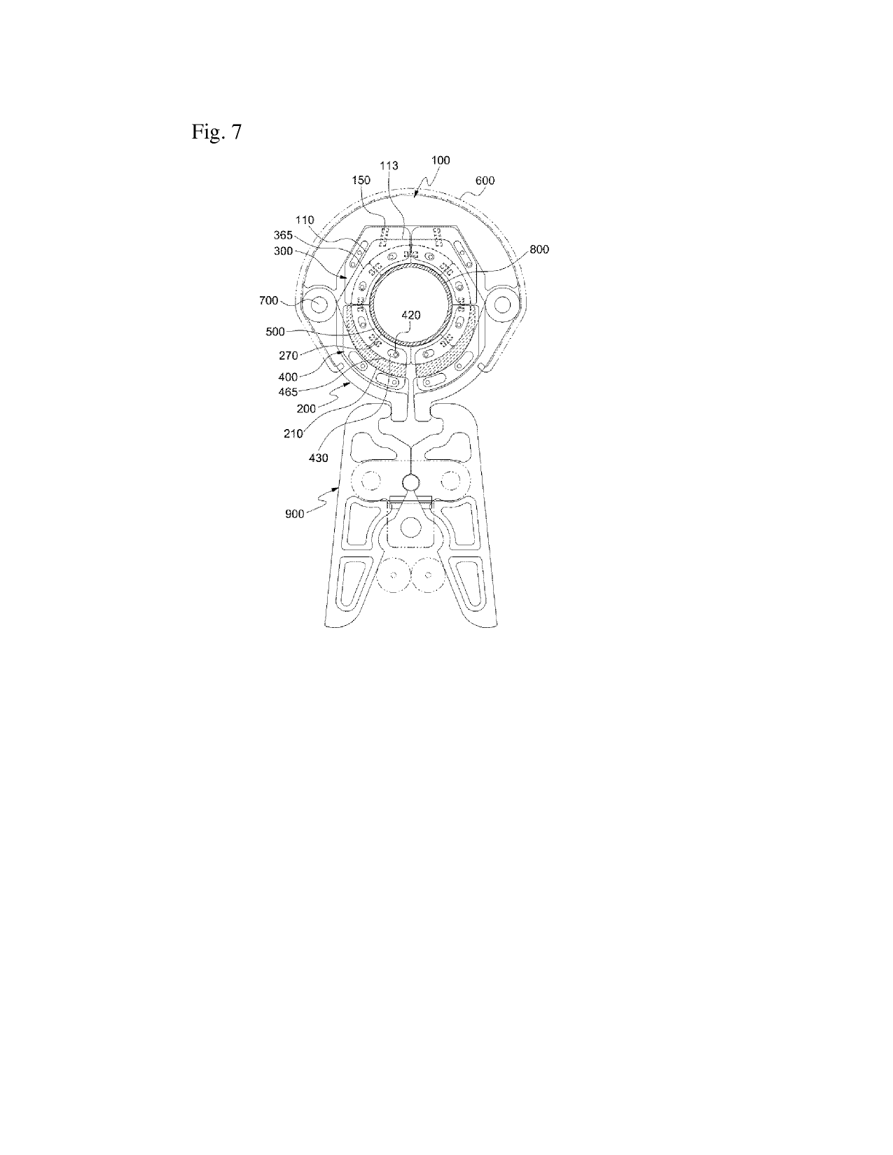

An operation of pressing the pipes using the pipe fitting and clamping apparatus according to the present invention will be described below with reference to FIG. 7. FIG. 7 is a perspective view showing the pipe fitting and clamping apparatus according to the present invention upon the pressing.

As shown in FIG. 7, when the pipe press instrument 900 is operated to rotate the pivot blocks 200 inward, the first resilient member 270 installed between the plurality of inserts 500 is compressed, and both ends in the longitudinal direction of the plurality of inserts 500 are approached each other.

More specifically, when the pivot blocks 200 are pressed by a gradually increased force using the pipe press instrument 900, a gap between the plurality of inserts 500 disposed at the front surface 365 of the second insert guide 400 is reduced, and the neighboring inserts 500 are pushed and raised along the front surface 465 by a repulsive force of the first resilient members 270 installed at both ends of the inserts 500.

As the inserts 500 slide along the front surface 465 of the second insert guide 400, the third spring pin 420 fastened to the insert 500 is blocked by the third spring pin guide hole 430 of the second insert guide, and the second insert guide 400 is pushed and raised along the second sliding surfaces 210 of the pivot blocks 200. In addition, the first insert guide 300 is also slid inward with respect to the fixed block 100 along the first sliding surface 110.

Here, since a thickness between the front surface 465 and the rear surface 460 of the second insert guide 400 is reduced toward the hinge pin 700, i.e., the thickness becomes T₂>T₁ as shown in FIG. 4, a component force is generated in a direction perpendicular to tangent plane of the front surface 465 of the second insert guide 400, i.e., toward a pipe center, by a wedge effect, and the inserts 500 can be strongly pushed toward the pipes.

Then, since a reaction force generated in a radial direction from the pipe center when a compression force is applied to the pipes is offset by the component force, the front surface 465 of the second insert guide 400 and the front surfaces 525 of the inserts can maintain a curved surface in a perfect circle shape even during the processing, and a cross section of the fitted pipes can have a perfect circle shape.

As described above, the plurality of insert 500, the second insert guide 400 and the first insert guide 300 are simultaneously slid by the operation of the pipe press instrument 900 to uniformly press the circumference of the pipes 800 to precisely press the pipes.

The foregoing description concerns an exemplary embodiment of the invention, is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

### INDUSTRIAL APPLICABILITY

According to the pipe fitting and clamping apparatus proposed by the present invention, since the pivot blocks are connected to both of the left and right ends of the fixed block to compress the pipes using the principle of the lever, the compressing force can be increased with a small force during the compressing operation to improve work convenience.

In addition, since the plurality of inserts are slid along the first and second insert guides to surround the entire circumference of the pipes and uniformly apply a pressure thereto upon rotation of the pivot blocks, the pipes can be compressed in a perfect circle shape.

Further, since the circumference of the pipes can be uniformly pressed and fitted to prevent the pipes from being deformed in an oval shape, a defect such as leakage from the connected pipes can be prevented and durability can be increased to extend an exchange period of the connected pipes.

1. A pipe fitting and clamping apparatus comprising:
a fixed block having a first sliding surface with a groove shape formed therein;
a pair of pivot blocks pivoted about hinge pins installed at both of left and right ends of the fixed block and having second sliding surfaces rounded at inner sides thereof;
a pair of first insert guides installed inside the fixed block and having rear surfaces which come in close contact with the first sliding surface and slide;
a pair of second insert guides installed inside the pivot blocks and rounded such that rear surfaces come in contact with the second sliding surface and slide; and
a plurality of inserts having front surfaces in contact with outer circumferential surfaces of pipes and rear surfaces which come in close contact with the front surfaces of the first insert guide and the second insert guide and slide.

2. The pipe fitting and clamping apparatus according to claim 1, wherein the second insert guide is rounded such that a thickness between the front surface and the rear surface is increased in a direction away from a center of the hinge pin.

3. The pipe fitting and clamping apparatus according to claim 1, wherein the rear surface of the second insert guide has a first curved surface having a predetermined circumferential length at an end thereof adjacent to the hinge pin and a second curved surface continuously formed from the first curved surface,
the first curved surface and the second curved surface have the same radius of curvature, and
a central point of curvature of the first curved surface from a central point of curvature of the front surface of the second insert guide is farther than from a central point of curvature of the second curved surface.

4. The pipe fitting and clamping apparatus according to claim 1, wherein a first resilient member is installed at surfaces of the plurality of inserts in contact with each other.

5. The pipe fitting and clamping apparatus according to claim 1, wherein a second resilient member is installed between a bottom surface of the first sliding surface and the first insert guide.

6. The pipe fitting and clamping apparatus according to claim 1, wherein a third resilient member having a band shape configured to surround the outside of the fixed block and pivot blocks is further installed.
